(19) United States
(12) Patent Application Publication
(10) Pub. No.: US 2017/0122871 A1
(43) Pub. Date: May 4, 2017

(54) METHOD FOR DETECTING SURFACE RESIDUES ON COMPONENTS USING UV RADIATION

(71) Applicant: Airbus Defence and Space GmbH, Taufkirchen (DE)

(72) Inventor: Thomas Meer, Egmating (DE)

(21) Appl. No.: 15/335,067

(22) Filed: Oct. 26, 2016

(30) Foreign Application Priority Data
Oct. 28, 2015 (DE) 102015221095.2

(51) Int. Cl. G01N 21/64; G01N 21/88

(52) U.S. Cl. CPC G01N 21/6456; G01N 21/8851; G01N 21/8806; G01N 2201/061

(57) ABSTRACT

A method for detecting surface residues on fiber composite plastic material components using ultraviolet radiation includes irradiating a surface of the component with ultraviolet radiation using an ultraviolet radiation source, detecting fluorescent radiation which is emitted from the surface of the component as a result of the irradiation with the ultraviolet radiation, and characterizing surface residues on the basis of the detected fluorescent radiation.

### CROSS-REFERENCES TO RELATED APPLICATIONS

This application claims the benefit of the German patent application No. 102015221095.2 filed on Oct. 28, 2015, the entire disclosures of which are incorporated herein by way of reference.

### FIELD OF THE INVENTION

The present invention relates to a method for detecting surface residues on fiber composite plastic material components using UV radiation. In particular, the present invention deals with detecting production-related surface residues on carbon-fiber-reinforced plastic material components for use in aircraft or spacecraft.

### BACKGROUND OF THE INVENTION

Although applicable in numerous applications for analyzing surfaces of a wide range of structures and various materials, the present invention and the problems on which it is based are described in greater detail in relation to surface analysis of aircraft structures made of carbon-fiber-reinforced plastic material.

For the industrial manufacture of molded components from fiber-reinforced plastic material (FRP), in particular carbon-fiber-reinforced plastic material (CFRP), molding tools are often used, in which the components are shaped. For this purpose, for example a fiber material semi-finished product, for example mats made of carbon fiber layers, can be impregnated with a liquid matrix material, for example epoxy resin, and cured in the molding tool by applying pressure and temperature. The mold surface of the molding tool determines the surface contour of the finished component which is left behind after curing. Molding tools of this type are often coated with a release agent before use so as to be able to release the finished components from the molding tool as easily as possible. On the side of the component remote from the molding tool, a peel-ply made of nylon or polyester or the like may be placed on the laminate construction of the component to be formed before curing, the peel-ply receiving the liquid matrix material and being removable again after curing. During curing, the peel-ply produces a defined and simultaneously roughened surface, which may be advantageous during further processing, for example for subsequent gluing to further components or subsequent coating of the component. After the component is demolded and the peel-ply is removed, undesired release agent residues or peel-ply residues may be left behind on the component, depending on the manufacturing method. These residues can influence the adhesion of glues or coatings.

Generally, it is desirable to form and obtain FRP components having as precisely defined and clean a surface as possible, so as to provide for further use or machining. Thus, for example, the adhesive properties of a component can be influenced if the surface thereof is soiled or comprises residues of undesired substances. Furthermore, good adhesion properties are advantageous for painting or coating a component. Accordingly, there is a need for methods which detect residues on surfaces of FRP components.

For example, X-ray photoelectron spectroscopy (XPS) makes it possible to analyze the chemical composition of the surface of small substance samples in a non-destructive manner in laboratory conditions. Furthermore, the wetting properties of a surface by liquids may be characteristic of the soiling or adhesiveness of the surface. If individual liquid drops are applied to the surface, conclusions can be drawn as regards the cleanness of the surface using contact angle measurements (CAM). In aerosol wetting, aerosol mist is sprayed onto surfaces over a large area, so as to determine the wetting properties similarly to using CAM. Furthermore, the wetting properties can also be used in further methods. So, for example, in a water brake test, the wetting of surfaces can be broadly determined using relatively large amounts of water. A sufficiently precise contact angle measurement of a structured surface, such as may be left behind after peel-ply removal, is found to be difficult.

### SUMMARY OF THE INVENTION

One of the ideas of the present invention is to find solutions for simple detection methods which make it possible to measure surface impurities over a large area even on structured and potentially rough surfaces, without soiling the surfaces with additional substances.

Accordingly, a method for detecting surface residues on fiber composite plastic material components is provided. The method comprises irradiating a surface of the component with ultraviolet radiation using an ultraviolet radiation source. The method further comprises detecting fluorescent radiation which is emitted by the surface of the component as a result of the irradiation with the ultraviolet radiation. The method further comprises characterizing surface residues on the basis of the detected fluorescent radiation.

One of the findings in the present invention involves using ultraviolet radiation for non-destructive analysis of surfaces of fiber-reinforced plastic material components. Particular peel-plies and other release agents have fluorescent properties under UV radiation. Production-related residues of these materials on surfaces can thus be made visible by illuminating the surfaces of the components with UV light. Under normal illumination in the visible spectrum, these residues are typically not visible. The fiber-reinforced plastic material, for example CFK or epoxy resin located on the surface, does not fluoresce in this case, and appears dark or black under UV radiation. The emitted fluorescent radiation can thus be used to characterize residues on the surface or material impurities thereon. In principle, in this way discrepancies in, damage to or contaminations of the surface can also be detected if they are apparent in the emitted fluorescent radiation.

A particular advantage of the solution according to the invention is that manufacturing errors or manufacture-related residues (for example peel-ply residues, fiber tears etc.) or the like can be established over a large area rapidly and directly on the analyzed component. For visual observation, for example even a UV emitter such as a black light emitter may be sufficient. Surface residues can be detected visually and subsequently eliminated or corrected. For example, surface treatment in the form of grinding may be provided, or the surface may be treated using an atmospheric pressure plasma or a laser. The method is thus particularly simple and cost-effective, among other things. In the case of the present invention, there is in particular no risk of contaminations or other changes in the surface as a result of the means used for the analysis.

Advantageous embodiments and developments may be derived from the further, dependent claims and from the description with reference to the drawings.

In some embodiments, detecting the fluorescent radiation may comprise detecting the fluorescent radiation using a fluorescent radiation detector. In this development, the fluorescent radiation may thus also be quantitatively detected, in such a way that it can for example be analyzed by appropriate means.

Detecting the fluorescent radiation may comprise measuring characteristic measurement variables of the detected fluorescent radiation. The characteristic measurement variables may for example be used as a basis for a subsequent analysis of the quality of the surface. In principle, a person skilled in the art can choose, depending on the requirements and the application, whether a relatively simple and thus robust analysis of a surface is preferred. Alternatively or in addition, for example, complex multivariate measurement variables may also be detected, on the basis of which the quality of a surface can be analyzed thoroughly and precisely.

The characteristic measurement variables may comprise radiation spectra and/or intensity distributions of the detected fluorescent radiation. For example, in this development, purely visual detection and characterization of the surface residues can be supplemented by or replaced with an intensity measurement. In this development, the method still requires extremely little expense, and can be used cost-effectively during small- or large-scale production. In principle, however, more complex spectroscopic measurements are also possible and provided within the scope of the invention.

In some embodiments, characterizing the surface residues may comprise analyzing the characteristic measurement variables of the detected fluorescent radiation using an analysis device. The analysis device may for example be set up to be fully or semi-automatic and for example contain a microprocessor and/or be connected to a data processing apparatus, a computer or the like. In principle, in this development the analysis may thus run automatically, it being possible, in particular, to make use of all of the tools and aids of electronic data analysis.

The analysis device may compare the characteristic measurement variables with one or more reference surfaces. For example, components may be provided comprising surfaces which are cleaned or which are soiled in a defined manner. Alternatively, components comprising specially prepared surfaces may be used. By calibrating the method according to the invention, it can for example be applied to reference components of this type having known properties. Analysis of the unknown surface residues of a component can be supplemented with the use of calibration components or calibration surfaces of this type, or the precision of said analysis can be improved by the use thereof.

In some embodiments, the method for detecting surface residues may be carried out on a surface of a carbon-fiber-reinforced plastic material (CFRP) component. Carbon-fiber-reinforced plastic material, in particular the epoxy resin used as a matrix material, appears dark or black under irradiation with ultraviolet radiation, in such way that fluorescent residues located thereon show up particularly well.

In some embodiments, the surface residues may comprise components of release agents for producing FRP components.

In some embodiments, the surface residues may comprise peel-ply residues. Peel-plies may for example be present in the form of nylon and/or polyester plies or the like.

The components of release agents may be characterized on the basis of area portions of the surface having increased intensity of the detected fluorescent radiation. For example, typical peel-plies or the coatings thereof fluoresce under UV radiation, in such a way that residues of plies of this type are clearly visible on a component of non-fluorescing or scarcely fluorescing CFRP.

In some embodiments, the surface residues may include surface damage. Whilst residues of peel-plies typically fluoresce strongly, fiber tears or the like of carbon fibers in a CFRP component appear particularly dark under irradiation with UV light, and can thus also be distinguished.

The surface damage may be characterized on the basis of area portions of the surface having a minimal intensity of the detected fluorescent radiation.

In some embodiments, the ultraviolet radiation source may be formed to emit ultraviolet radiation in near ultraviolet at wavelengths in the range of 310 nm to 400 nm. The ultraviolet radiation source may accordingly in particular be a UVA-A light source, in other words emit black light.

The above embodiments and developments can be combined in any desired manner, within reason. Further possible embodiments, developments and implementations of the invention also include combinations not explicitly mentioned of features of the invention which are disclosed above or in the following in relation to the embodiments. In particular, a person skilled in the art will also add individual aspects to the relevant basic form of the present invention as improvements or additions.

### BRIEF DESCRIPTION OF THE DRAWINGS

In the following, the present invention is described in greater detail by way of the embodiments set out in the schematic drawings, in which:

FIG. 1 is a schematic plan view of a surface of a CFRP component which is being irradiated using an ultraviolet radiation source in a method in accordance with some embodiments of the invention;

FIG. 2 is a schematic plan view of a surface of a CFRP component which is being irradiated using an ultraviolet radiation source in a method in accordance with some further embodiments of the invention;

FIG. 3 is a schematic flow chart of a method for detecting surface residues on components of fiber composite plastic material in accordance with some further embodiments of the invention.

### DETAILED DESCRIPTION OF THE PREFERRED EMBODIMENTS

The accompanying drawings are intended to provide further understanding of the embodiments of the invention. They illustrate embodiments and are intended to explain principles and concepts of the invention in conjunction with the description. Other embodiments and many of the aforementioned advantages may be seen from the drawings. The elements of the drawings are not necessarily to scale.

In the drawings, like, functionally equivalent and equivalently acting elements, features and components are provided with like reference numerals in each case, unless indicated otherwise.

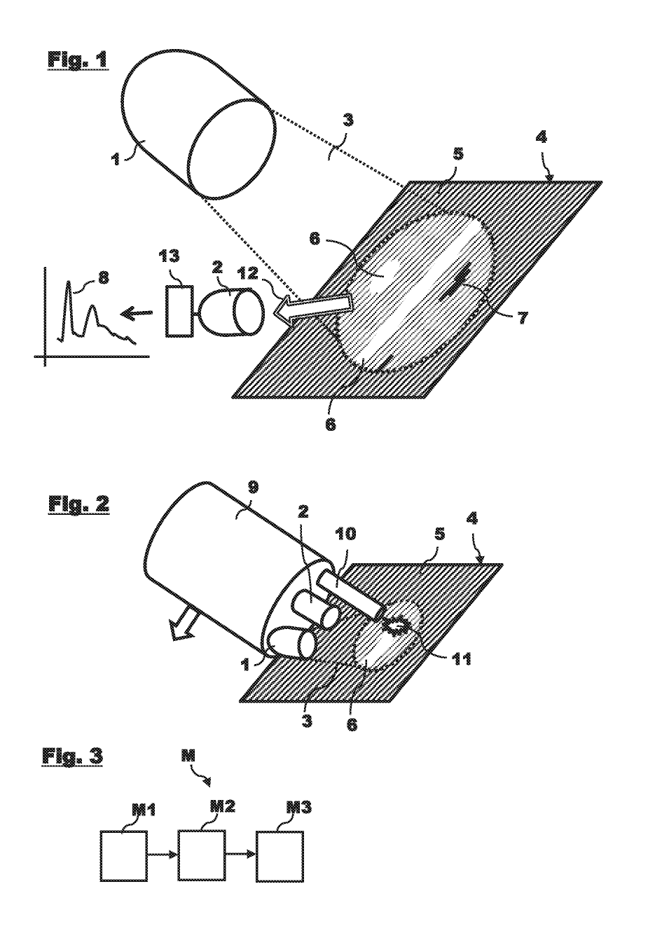

FIG. 1 is a schematic plan view of a surface of a CFRP component which is being irradiated using an ultraviolet radiation source in a method in accordance with an embodiment of the invention. In this connection, FIG. 3 is a schematic flow chart of the underlying method for detecting surface residues on fiber composite material components.

In FIG. 1, reference numeral 4 denotes a component. For example, this may be a carbon-fiber-reinforced plastic material (CFRP) component 4, the surface 5 of which is soiled or contaminated with surface residues 6 of release agents or release materials. In particular, this may be a component 4 for use in aircraft or spacecraft, such as a structural component (stringer, former, skin field portion or the like) or a cabin equipment element, etc. The surface residues 6 may for example be remainders or residues of peel-plies from the manufacturing process of the component 4 which have not been fully removed when pulled off after the component 4 cures or have left behind non-visible residues. These surface residues 6 may interfere with subsequent adhesion and/or coating processes and are thus preferably removed, for example by grinding, lasing and/or plasma treatment. Furthermore, the component 4 may comprise surface damage 7 or similar undesired production errors. For example, surface damage 7 of this type may include one or more fiber tears in the carbon fibers of the component 4. The method M described in the following serves to detect surface residues 6 on fiber composite plastic material components 4.

As is schematically shown in FIG. 3, the method M comprises at M1 the step of irradiating the surface 5 of the component 4 with ultraviolet radiation 3 using an ultraviolet radiation source 1, for example a UV emitter, a black light lamp or the like. For example, the ultraviolet radiation source 1 may emit ultraviolet radiation 3 in near ultraviolet at wavelengths in the range of 310 nm to 400 nm, in particular of 320 nm to 380 nm (UV-A). The method M further comprises at M2 the step of detecting fluorescent radiation 12 emitted from the surface 5 of the component 4 as a result of the irradiation with the ultraviolet radiation 3. Finally, at M3, the method M comprises the step of characterizing the surface residues 6 on the basis of the detected fluorescent radiation 12.

Peel-plies and other surface residues 6 can fluoresce as soon as they are irradiated with the ultraviolet radiation 3 (see FIG. 1). By contrast, the fiber-reinforced plastic material of the component 4 may fluoresce to a much lesser extent, and appear dark or black under the ultraviolet radiation 3 (in particular the fiber tears, in other words the surface damage 7). Discrepancies in the surface 5 of the component 4 in the form of surface residues 6 can thus be established over a large area without high expense directly on the analyzed component 4, by detecting area portions of the surface 5 having an increased intensity of fluorescent radiation 12. For visual observation, for example, even a UV emitter such as a black light emitter may be sufficient. Surface residues 6 can be detected visually and subsequently eliminated or corrected. For example, surface treatment in the form of grinding may be provided, or the surface 5 may be treated using an atmospheric pressure plasma or a laser. In the present case, there is no risk of soiling or contaminating the surface 5. For example, no analysis media such as water, aerosols or the like are applied to the component 4. In particular, the method M according to the present invention is non-destructive.

In some embodiments, the method M may provide that the fluorescent radiation 12 is not merely visually detected, but rather analyzed more precisely using spectroscopic intensity measurements or similar methods. For this purpose, the method M may comprise detecting the fluorescent radiation 12 using a fluorescent radiation detector 2 (see FIG. 1), by means of which characteristic measurement variables 8 of the detected fluorescent radiation 12 can be measured. For example, the characteristic measurement variables 8 may comprise radiation spectra and/or intensity distributions or the like of the detected fluorescent radiation 12. Furthermore, an analysis device 13 may be provided, which can analyze the characteristic measurement variables 8 of the detected fluorescent radiation 12 using statistical data analysis methods. This may, for example, include comparing the characteristic measurement variables 8 with one or more reference surfaces. For this purpose, the analysis device 13 may be formed so as to generate an evaluation result, in particular on the basis of univariate and/or multivariate analysis methods. For example, the reference surfaces may serve to calibrate the method in that values for the characteristic measurement variables 8 are initially obtained for the reference surfaces (for example, also by the method M according to the invention). For example, for this purpose, components 4 may be provided having surfaces which are cleaned or which are prepared in a defined manner. The analysis device 13 may, for example, contain a microprocessor or the like, by means of which the characteristic measurement variables can be evaluated fully automatically and can additionally be processed further in digital form or can be passed to external data processing apparatuses via data networks.

FIG. 2 is a schematic plan view of a surface 5 of a CFRP component 4 which is being irradiated using an ultraviolet radiation source 1 in a method M in accordance with a further embodiment of the invention.

In principle, the method M is basically similar to the method disclosed in connection with FIGS. 1 and 3. However, the method M in FIG. 2 is explicitly carried out by a robot arm 9. For this purpose, the robot arm 9 comprises an ultraviolet radiation source 1, a fluorescent radiation detector 2 and a plasma nozzle 10. For example, the robot arm 9 may be configured to travel along the surface 5 of a component 4 (as indicated by an arrow in FIG. 2) and in doing so to irradiate said component with ultraviolet radiation 3. At the same time, the fluorescent radiation detector 2 detects fluorescent radiation 12 emitted by the surface 5, and, on this basis, measures characteristic measurement variables 8 of the fluorescent radiation 12. The robot arm 9 may further comprise an analysis device 13 (not shown), which is coupled to the fluorescent radiation detector 2 and the ultraviolet radiation source 1 and connected to a control device (also not shown) of the robot arm 9. For example, the control device may control the robot arm 9 on the basis of an analysis result of the fluorescent radiation 12, said result being obtained from the measured characteristic measurement variables by the analysis device 13, and if appropriate activate the plasma nozzle 10 for plasma treatment 11 of surface residues 6 on the surface 5 of the component 4. A robot arm 9 of this type could also analyze components 4 to some extent for surface residues 6 or surface damage 7 fully automatically, and if applicable eliminate or correct them directly. A person skilled in the art will deduce from the context that, as an alternative or in addition to plasma treatment 11, grinding tools and/or laser apparatuses or similar tools may also be provided to machine the surface 5.

In the above detailed description, various features have been combined in one or more examples to improve the cogency of what is described. However, it should be clear that the above description is merely illustrative and in no way limiting in nature. It is intended to cover all alternatives, modifications and equivalents of the various features and embodiments. Many other examples will be immediately and directly apparent to a person skilled in the art in view of the above description as a result of his expert knowledge.

The embodiments have been selected and described so as to be able to represent as clearly as possible the principles behind the invention and the possible applications thereof in practice. As a result, skilled persons can modify and use the invention and the various embodiments thereof optimally in relation to the intended purpose of use. In the claims and description, the terms “containing” and “having” are used as neutral terms for the corresponding concepts “comprising”. Furthermore, the use of the terms “a”, “an” and “one” does not in principle exclude the possibility of a plurality of the features and components thus described.

In addition, in this disclosure, the terms “comprise” or “comprising” do not exclude other elements or steps and the term “or” means either or both. Furthermore, characteristics or steps which have been described may also be used in combination with other characteristics or steps and in any order unless the disclosure or context suggests otherwise. This disclosure hereby incorporates by reference the complete disclosure of any patent or application from which it claims benefit or priority.

1. A method for detecting surface residues on components made of fiber composite plastic material using ultraviolet radiation, wherein the method comprises the following method steps:
irradiating a surface of the component with ultraviolet radiation using an ultraviolet radiation source;
detecting fluorescent radiation which is emitted from the surface of the component as a result of the irradiation with the ultraviolet radiation; and
characterizing surface residues on the basis of the detected fluorescent radiation.

2. The method of claim 1, wherein detecting the fluorescent radiation comprises detecting the fluorescent radiation using a fluorescent radiation detector.

3. The method of claim 2, wherein detecting the fluorescent radiation comprises measuring characteristic measurement variables of the detected fluorescent radiation.

4. The method of claim 3, wherein the characteristic measurement variables comprise at least one of radiation spectra or intensity distributions of the detected fluorescent radiation.

5. The method of claim 3, wherein characterizing the surface residues comprises analyzing the characteristic measurement variables of the detected fluorescent radiation using an analysis device.

6. The method of claim 5, wherein the analysis device compares the characteristic measurement variables with one or more reference surfaces.

7. The method of claim 1, wherein the method for detecting surface residues is carried out on a surface of a component made of carbon-fiber-reinforced plastic material.

8. The method of claim 1, wherein the surface residues comprise components of release agents for producing fiber composite plastic components.

9. The method of claim 8, wherein the surface residues comprise peel-ply residues.

10. The method of claim 7, wherein the components of release agents are characterized on the basis of area portions of the surface having an increased intensity of the detected fluorescent radiation.

11. The method of claim 1, wherein the surface residues include surface damage.

12. The method of claim 11, wherein the surface damage is characterized on the basis of area portions of the surface having a minimal intensity of the detected fluorescent radiation.

13. The method of claim 1, wherein the ultraviolet radiation source is formed to emit ultraviolet radiation in near ultraviolet at wavelengths in the range of 310 nm to 400 nm.
